(19) United States
(12) Patent Application Publication
(10) Pub. No.: US 2011/0199516 A1
(43) Pub. Date: Aug. 18, 2011

(54) METHOD OF SHOWING VIDEO ON A TOUCH-SENSITIVE DISPLAY

(75) Inventors: Jason Laberge, New Brighton, MN (US); Pallavi Dharwada, Minneapolis, MN (US)

(73) Assignee: Honeywell International Inc., Morristown, NJ (US)

(21) Appl. No.: 12/704,950

(22) Filed: Feb. 12, 2010

(51) Int. Cl. G06F 3/041; H04N 5/262

(52) U.S. Cl. 348/240.99; 345/173; 348/E05.055

(57) ABSTRACT

A method of showing video on a touch-sensitive display. The method includes showing video on a touch-sensitive display and detecting contact with the video on the touch-sensitive display. The method further includes manipulating a camera that is recording the video based on contact with the video on the touch-sensitive display.

### BACKGROUND

Monitoring large and complex environments is a challenging task for security operators because situations evolve quickly, information is distributed across multiple screens and systems, uncertainty is rampant, decisions can have high risk and far reaching consequences, and responses must be quick and coordinated when problems occur. The increased market present of single-touch and multi-touch interaction devices such as the iPhone, GPS navigators, HP TouchSmart laptop, Microsoft Surface and Blackberry mobile devices offer a significant opportunity to investigate new gesture-based interaction techniques that can improve operator performance during complex monitoring and response tasks.

However, the solutions that are typically incorporated to address the myriad of needs in complex security environments often consist of adding a multitude of features and functions in order to facilitate monitoring the environment using multiple cameras. Unfortunately, one consequence of adding additional features in order to facilitate monitoring multiple cameras is that operators must remember the features available, including when and how to access them.

### BRIEF DESCRIPTION OF THE DRAWINGS

FIGS. 1A-1B illustrate an example method of showing video on a touch-sensitive display.

FIGS. 2A-2B illustrate another example method of showing video on a touch-sensitive display.

FIGS. 3A-3B illustrate yet another example method of showing video on a touch-sensitive display.

FIGS. 4A-4B illustrate an example method of showing a video on a window on a touch-sensitive display.

FIGS. 5A-5B illustrate an example method of showing a plurality of videos on a touch-sensitive display.

FIG. 6 is a block diagram of an example system for executing the method described herein with reference to FIGS. 1-5.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

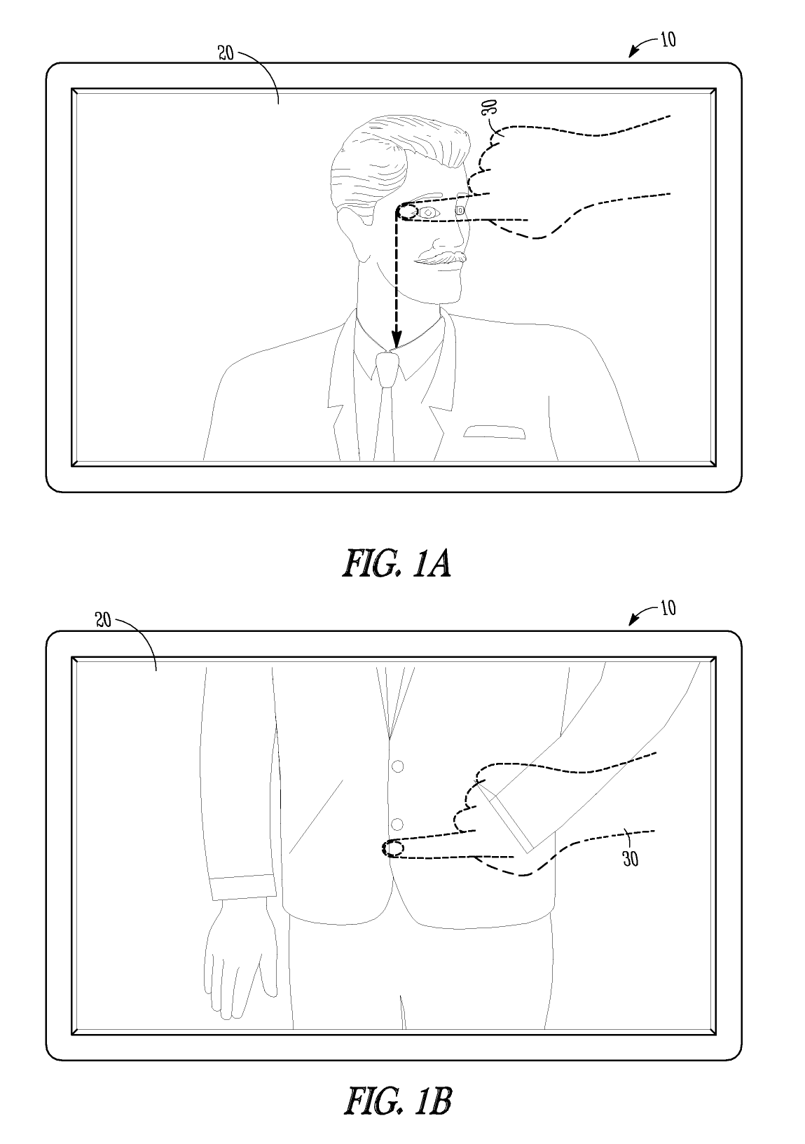

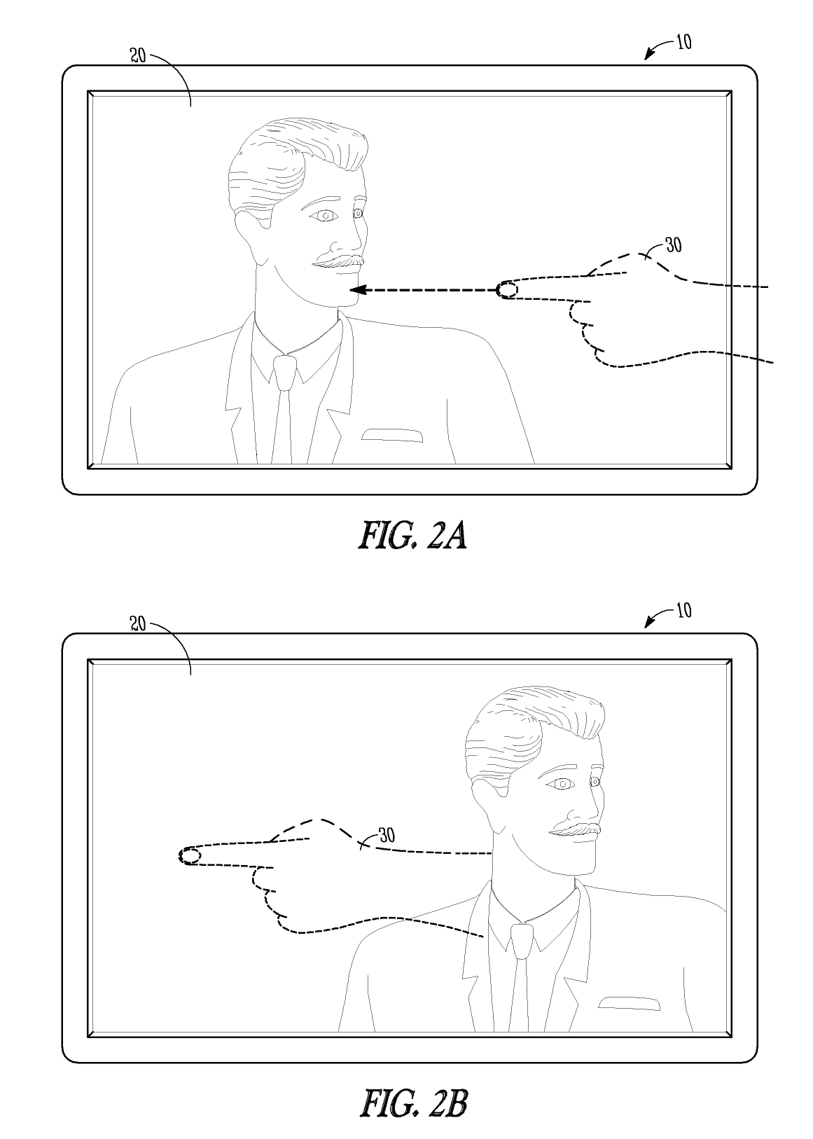

FIGS. 1A-1B illustrate an example method that includes showing video 20 on a touch-sensitive display 10 and detecting contact (FIG. 1A) with the video 20 on the touch-sensitive display 10. FIG. 1B illustrates that the method further includes manipulating a camera (not shown) that is recording the video 20 based on contact with the video 20 on the touch-sensitive display 10.

In some embodiments, manipulating the camera based on contact with the video 20 on the touch-sensitive display 10 includes adjusting the tilt angle of the camera. In the example embodiment is illustrated in FIGS. 1A-1B, adjusting the tilt angle of the camera includes moving one finger 30 vertically across the video 20 on the touch-sensitive display 10.

FIGS. 2A-2B illustrate an example embodiment of the method where manipulating the camera based on contact with the video 20 on the touch-sensitive display 10 includes manipulating zoom functioning of the camera. FIG. 2A illustrates detecting contact with the video 20 on the touch-sensitive display 10. FIG. 2B shows a user 30 manipulating the zoom of a camera by placing fingers 30 on the video 20 and moving the fingers 30 in an arcing motion on the touch-sensitive display 10. In some embodiments, moving the fingers 30 toward one another in an arcing motion will cause the camera to zoom forward toward a subject while moving fingers away from one another will cause the camera to zoom away from the subject.

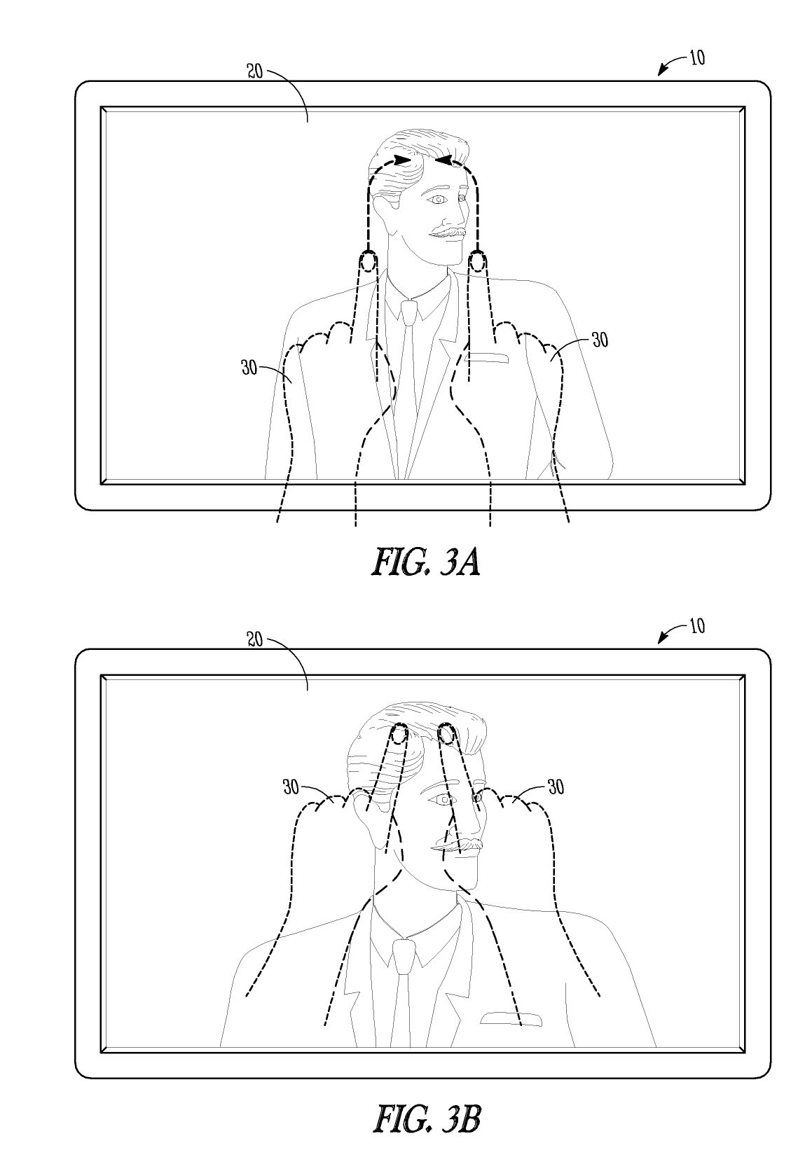

FIGS. 3A-3B illustrate an example embodiment of the method where manipulating the camera based on contact with the video 20 on the touch-sensitive display 10 includes manipulating a pan angle of the camera. FIG. 3A illustrates detecting contact with the video 20 on the touch-sensitive display 10. FIG. 3B shows a user 30 manipulating the pan angle of a camera by placing a finger 30 on the video 20 and moving the finger 30 laterally on the touch-sensitive display 10.

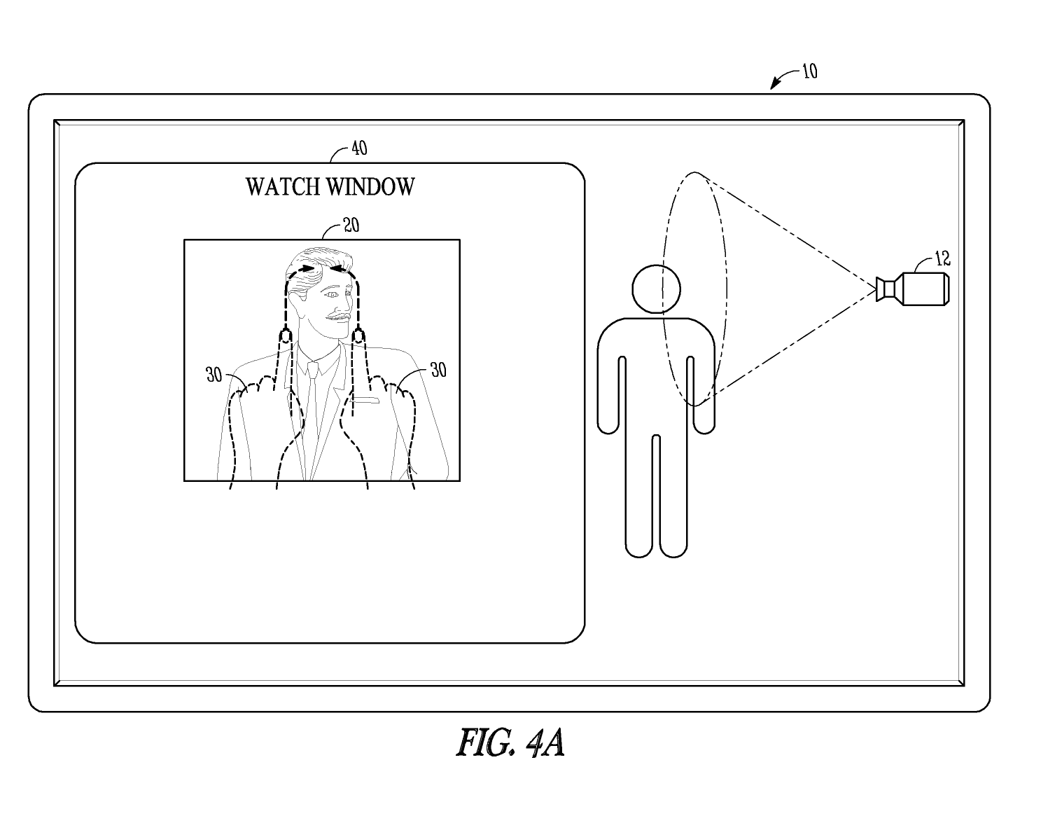

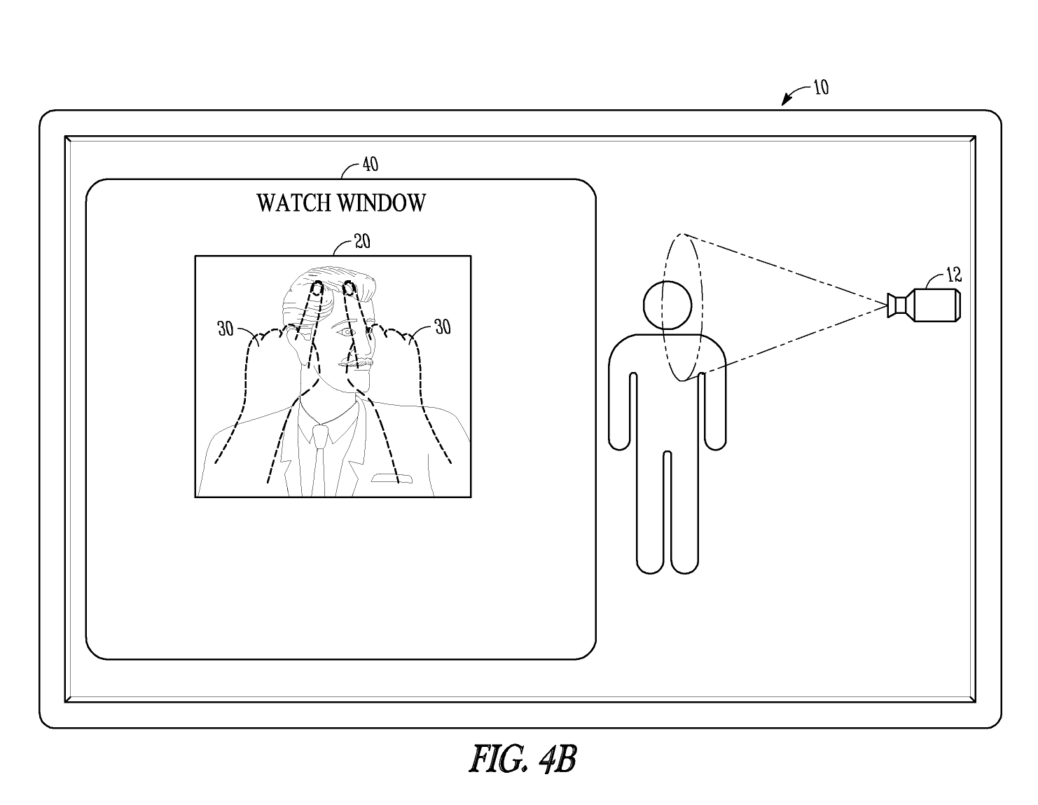

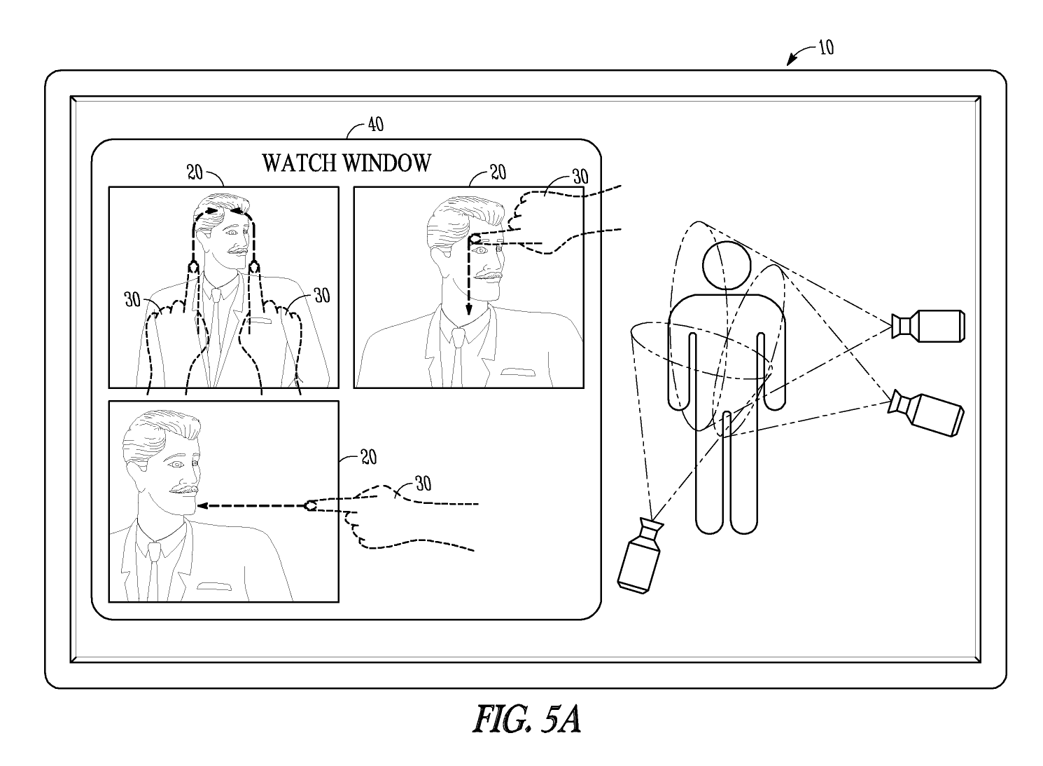

FIGS. 4A-4B illustrate an example embodiment where showing video 20 on a touch-sensitive display 10 includes showing video 20 on a window 40 on the touch-sensitive display 10. In some embodiments, showing video 20 on a window 40 on the touch-sensitive display 10 includes displaying a thumbnail video 20 on the window 40 on the touch-sensitive display 10.

FIG. 4A illustrates detecting contact with the thumbnail video 20 on the window 40. FIG. 4B shows a user 30 manipulating a camera 12 by placing a finger 30 on the thumbnail video 20 and moving the finger 30 on the touch-sensitive display 10.

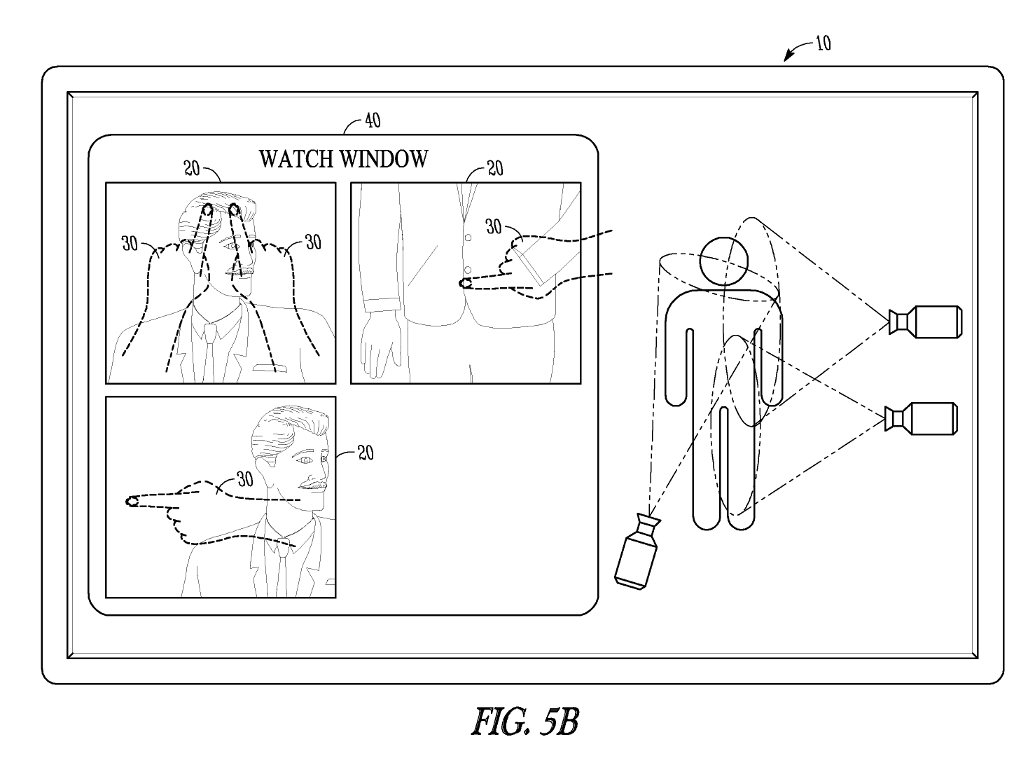

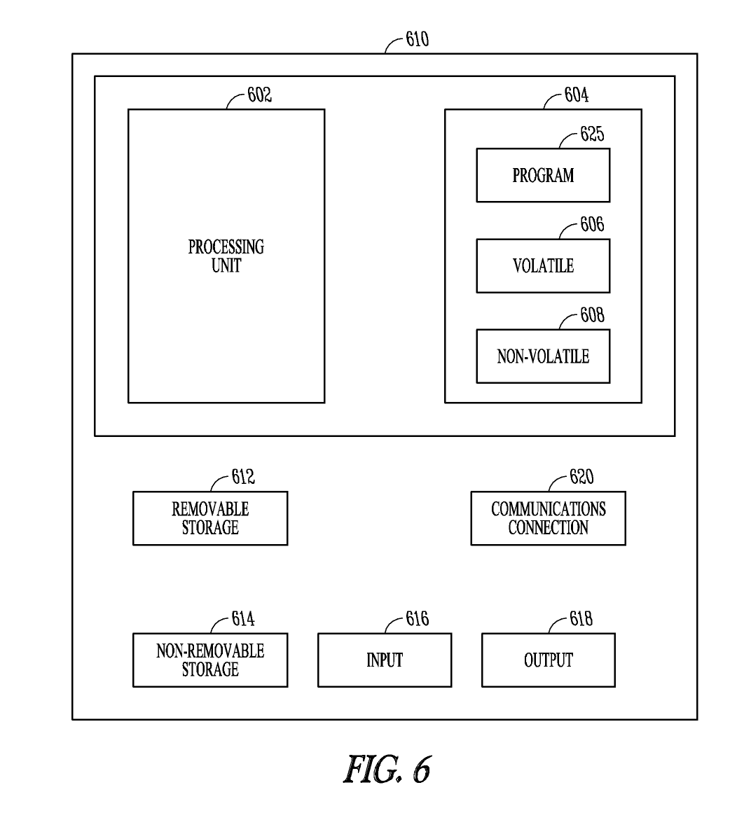

FIGS. 5A-5B illustrate an example embodiment where showing video 20 on a touch-sensitive display 10 includes showing a plurality videos 20 on a touch-sensitive display 10. In some embodiments, showing a plurality videos 20 on a touch-sensitive display 10 may include showing a plurality videos 20 on a window 40 on the touch-sensitive display 10. In the example embodiment illustrated in FIGS. 5A-5B, showing a plurality videos 20 on the window 40 includes displaying a plurality of thumbnail videos 20 on the window 40 on the touch-sensitive display 10.

FIG. 5A illustrates detecting contact with at least one of the thumbnail videos 20 on the window 40. FIG. 5B shows a user 30 manipulating one or more cameras 12 by placing a finger(s) 30 on one or more of the thumbnail videos 20 and moving the finger(s) 30 on the touch-sensitive display 10.

It should be noted while the FIGS. illustrate static video 20 on the touch-sensitive display 10, all of the contemplated embodiments may display real-time live video 20 on the touch-sensitive display 10.

The methods described herein may help security personnel to effectively support security monitoring and response tasks. Users can interact with a touch-sensitive display by using intuitive gestures that support performing tasks and activities such as monitoring un-related assets and/or responding to an incident. The information provided on the display gives the context that is needed for effective interaction by users with assets (e.g., cameras) within a complex environment. Users can effectively interact (i.e., view and/or adjust) with assets using a variety of single-touch and multi-touch gestures on the touch-sensitive display.

A block diagram of a computer system that executes programming 625 for performing the above method is shown in FIG. 6. The programming may be written in one of many languages, such as virtual basic, Java and others. A general computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 610 may include or have access to a computing environment that includes input 616, output 618, and a communication connection 620. The input 616 may be a keyboard and mouse/touchpad, or other type of data input device, and the output 618 may be a display device or printer or other type of device to communicate information to a user. In one embodiment, a touch screen device may be used as both an input and an output device.

The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 610. A hard drive, CD-ROM, and RAM are some examples of articles including a computer-readable medium.

The method described herein may help to provide on-demand assistance to help users know the features and functions available at any given time. The on-demand assistance is a context aware overlay that is activated when the user places at least one finger on the touch-sensitive display. In some embodiments, the overlay is semi-transparent so as not to occlude the critical information shown in the environment that is shown on the display. Showing the overlay may help users remember the features or functions available by reinforcing the options available. The need for an overlay may be reduced with repeated use because users may be more likely to remember the options available and how to use them.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A method of showing video on a touch-sensitive display comprising:
showing video on a touch-sensitive display;
detecting contact with the video on the touch-sensitive display; and
manipulating a camera that is recording the video based on contact with the video on the touch-sensitive display.

2. The method of claim 1, wherein manipulating the camera based on contact with the video on the touch-sensitive display includes adjusting the tilt angle of the camera.

3 The method of claim 2, wherein adjusting the tilt angle of the camera includes moving one finger vertically across the video on the touch-sensitive display.

4. The method of claim 1, wherein manipulating the camera based on contact with the video on the touch-sensitive display includes manipulating zoom functioning of the camera.

5. The method of claim 4, wherein manipulating zoom functioning of the camera includes moving two fingers in arcing motion across the video on the touch-sensitive display.

6. The method of claim 1, wherein manipulating the camera based on contact with the video on the touch-sensitive display includes manipulating a pan angle of the camera.

7. The method of claim 6, wherein manipulating a pan angle of the camera includes moving one finger laterally across the video on the touch-sensitive display.

8. The method of claim 1, wherein showing video on a touch-sensitive display includes showing video on a window on the touch-sensitive display.

9. The method of claim 8, wherein showing video on a window on the touch-sensitive display includes displaying a thumbnail video.

10. The method of claim 1, wherein showing video on a touch-sensitive display includes showing a plurality videos on a touch-sensitive display, and wherein manipulating the camera based on contact with the video on the touch-sensitive display includes manipulating a plurality of cameras based on contact with each of the videos on the touch-sensitive display.

11. A system comprising:
a touch-sensitive display;
a processor that shows video on a touch-sensitive display; wherein the processor detects contact with the video on the touch-sensitive display, and wherein the processor manipulates a camera that is recording the video based on contact with the video on the touch-sensitive display.

12. The system of claim 11 wherein the processor adjusts the tilt angle of the camera.

13. The system of claim 12 wherein the processor adjusts the tilt angle of the camera when a user moves one finger vertically across the video on the touch-sensitive display.

14. The system of claim 11 wherein the processor manipulates zoom functioning of the camera.

15. The system of claim 14 wherein the processor manipulates zoom functioning of the camera when a user moves two fingers in an arcing motion across the video on the touch-sensitive display.

16. The system of claim 11 wherein the processor manipulates a pan angle of the camera.

17. The system of claim 16 wherein the processor manipulates a pan angle of the camera when a user moves one finger laterally across the video on the touch-sensitive display.

18. The system of claim 11 wherein the processor shows video on a window shown on the touch-sensitive display.

19. The system of claim 18 wherein the processor displays a thumbnail video on the window.

20. The system of claim 11 wherein the processor shows a plurality videos on the touch-sensitive display and manipulates a plurality of cameras based on contact with each of the videos on the touch-sensitive display.
